(19) United States
(12) Patent Application Publication
(10) Pub. No.: US 2020/0357351 A1
(43) Pub. Date: Nov. 12, 2020

(54) Method for Driving Liquid Crystal Display Apparatus

(71) Applicant: HKC Corporation Limited, Shenzhen City (CN)

(72) Inventor: Huailiang He, Shenzhen City (CN)

(21) Appl. No.: 16/640,637

(22) PCT Filed: Nov. 15, 2017
(86) PCT No.: PCT/CN2017/111196

§ 371 Date: Feb. 20, 2020

(30) Foreign Application Priority Data
Aug. 25, 2017 (CN) 201710743061.0

(51) Int. Cl. G09G 3/36; G02F 1/133

(52) U.S. Cl. CPC G09G 3/3607; G02F 1/13306; G09G 2330/021; G09G 2300/0421; G09G 3/3677

(57) ABSTRACT

In a method for driving a liquid crystal display apparatus, the liquid crystal display apparatus includes a liquid crystal layer divided into a plurality of pixels. Each pixel includes a first sub-pixel and a second sub-pixel. The method includes: when each pixel displays a grayscale gk, applying a voltage V1(gk) to the first sub-pixel and applying a voltage V2(gk) to the second sub-pixel, and setting ΔV12(gk)=V1(gk)−V2(gk), where 0≤gk≤n, gk and n are integers greater than 0, and n represents the highest-brightness grayscale. When the grayscale gk is smaller than a predetermined grayscale gs, the voltages V1(gk) V2(gk) are applied such that ΔV12(gk)>0V, and the relation ΔV12(gk)>ΔV12(gk+1) is satisfied. When the grayscale gk is equal to or greater than the predetermined grayscale gs, V1(gk)=V2(gk) is set such that ΔV12(gk)=0V and the relation ΔV12(gk)=ΔV12(gk+1) is satisfied.

### CROSS-REFFERENCE TO RELATED APPLICATION

This application claims priority to China Patent Application No. 201710743061.0 filed on Aug. 25, 2017, and entitled “Driving method of liquid crystal display device” at State Intellectual Property Office of the P.R.C, the entirety of which is hereby incorporated by reference.

### FIELD OF INVENTION

The present invention relates to a method for driving a liquid crystal display apparatus, in particular to the technology of improving the gamma (γ) characteristic of different viewing angles of a liquid crystal display apparatus.

### BACKGROUND OF INVENTION

### 1. Description of the Related Art

A liquid crystal display apparatus is a panel display apparatus with the advantages of high resolution, thin shape, light weight, and low power consumption. In recent years, the display function, productivity, and price competition with other display apparatuss are improved, and thus the market scale of the LCD apparatuss expands rapidly.

A conventional twisted neumatic (TN) liquid crystal display apparatus can arrange the long axis of the liquid crystal molecules with a positive dielectric rate and an anisotropy substantially parallel to the substrate surface, and carry the orientation processing, so that the long axis of the liquid crystal molecules can be twisted for substantially 90 degrees between the upper and lower substrates and along the thicknesswise direction of the liquid crystal layer. If a voltage is applied to the liquid crystal layer, the liquid crystal molecules are resumed to be parallel to the electric field to release the twisted orientation. The TN liquid crystal display apparatus can control the transmittance by using the liquid crystal molecules according to the optical property of the orientation change of the voltage.

The TN liquid crystal display apparatuss have excellent production margin and productivity. On a hand, there is a problem of the display function particularly the viewing angle characteristic. Specifically, the contrast of the display of the TN liquid crystal display apparatus drops significantly when the display of the TN liquid crystal display apparatus is viewed from an oblique direction, and the brightness difference between the grayscales become unobvious when the images of several grayscales from black to white are observed from the oblique direction and the front direction. On the other hand, the inversion of the grayscales of the display may result in a darker portion observed from the front and a brighter portion is observed from the oblique direction (which is known as “grayscale inversion”).

In recent years, the TN liquid crystal display provided as a liquid crystal display apparatus for improving the characteristic of the viewing angle is designed and developed with an in-plane switching (IPS) mode, a multi-domain vertical alignment (MVA) mode, an axially symmetric aligned microcell (ASM) mode, etc. The liquid crystal display apparatus with these viewing angle modes can overcome the aforementioned problem with regard to the characteristic of the viewing angle. In other words, these liquid crystal display apparatuss do not have the issues of having a significantly low contrast when viewing a display surface from an oblique direction or having a grayscale inversion of the display.

The so-called γ characteristic refers to the dependence of grayscale indicating the brightness, and the γ characteristic differs in the front direction and the oblique direction. Since the grayscale display status differs with the observing direction, therefore problems may occur easily in the case of showing the image of a photo or displaying a TV program. The problem of the viewing angle dependence of the γ characteristic in the MVA and ASM modes is more obvious than that of the IPS mode. On one hand, it is very difficult to produce high contrast panels when viewing from the front side with high productivity, when the IPS is compared with the MVA and ASM modes. Based on these, the present invention expects to improve the viewing angle dependence of the γ characteristic in the liquid crystal display apparatuss of the MVA mode and/or the ASM mode.

### 2. Summary of the Invention

In view of the aforementioned problems of the prior art, it is a primary objective of the present invention to provide a method for driving a liquid crystal display apparatus capable of improving the conventional liquid crystal display apparatus having the γ characteristic of different viewing angles.

To achieve the aforementioned and other objectives, the present invention provides a liquid crystal display apparatus, including: a liquid crystal layer. The liquid crystal layer is divided into a plurality of pixels, and displayed in a normal-black manner. The plurality of pixels has a plurality of electrodes applying a voltage to the liquid crystal layer. Wherein, each of the pixels includes a first sub-pixel and a second sub-pixel, and a voltage is applied to the liquid crystal layer of each pixel separately; when each of the pixels displays a grayscale gk, the voltages applied to the liquid crystal layer of the first sub-pixel and the second sub-pixel of each pixel are V1(gk) and V2(gk) respectively, and ΔV12(gk)=V1(gk)−V2(gk) is set, wherein 0≤gk≤n, gk and n are integers greater than 0, and n stands for the highest-brightness grayscale. When the grayscale gk is smaller than a predetermined grayscale gs, ΔV12(gk)>0V is set, and the relation ΔV12(gk)>ΔV12(gk+1) is satisfied, and when the grayscale gk is equal to or greater than the predetermined grayscale gs, ΔV12(gk)=0V is set, and the relation ΔV12(gk)=ΔV12(gk+1) is satisfied.

Preferably, each of the pixels further includes a third sub-pixel which is different from the first sub-pixel and the second sub-pixel. When each of the pixels displays the grayscale gk, a voltage V3(gk) is applied to the liquid crystal layer of the third sub-pixel, and ΔV13(gk)=V1(gk)−V3(gk) is set, and when the grayscale gk is smaller than a predetermined grayscale gs, ΔV13(gk)>0V is set, and the relation ΔV12(gk)<ΔV13(gk) is satisfied, and when the grayscale gk is equal to or greater than the predetermined grayscale gs, ΔV13(gk)=0V is set, and the relation ΔV12(gk)=ΔV13(gk) is satisfied.

Preferably, the first sub-pixel includes a first transistor electrically coupled to a first source line. The second sub-pixel includes a second transistor electrically coupled to a second source line, and the first source line and the second source line are parallel to each other and provide a voltage signal to the first sub-pixel and the second sub-pixel separately. The first transistor and the second transistor are electrically coupled to a gate line and provide the same scan signal to the first sub-pixel and the second sub-pixel.

Preferably, when the voltage V1(gk) is smaller than predetermined voltage Vs, ΔV12(gk)>0V is set, and the relation ΔV12(gk)>ΔV12(gk+1) is satisfied; and when the voltage V1(gk) is equal to or greater than the predetermined voltage Vs, ΔV12(gk)=0V is set, and the relation ΔV12(gk)=ΔV12(gk+1) is satisfied.

Preferably, the highest-brightness grayscale n is 256 and the predetermined grayscale gs is 128.

Preferably, the pixels are array pixels.

In a preferred embodiment of the present invention, a liquid crystal display apparatus includes a liquid crystal layer. The liquid crystal later is divided into a plurality of pixels and displayed in a normal-black manner. The plurality of pixels has a plurality of electrodes applying a voltage to the liquid crystal layer. Wherein each of the pixels includes a first sub-pixel and a second sub-pixel, and a voltage is applied to the liquid crystal layer of each pixel separately; When each of the pixels displays a grayscale gk, the voltages applied to the liquid crystal layer of the first sub-pixel and the second sub-pixel of each pixel are V1(gk) and V2(gk) respectively, ΔV12(gk)=V1(gk)−V2(gk) is set, wherein 0≤gk≤n, gk and n are integers greater than 0, and n stands for the highest-brightness grayscale, and when the grayscale gk is smaller than a predetermined grayscale gs, ΔV12(gk)>0V is set, and the relation ΔV12(gk)=ΔV12(gk+1) is satisfied, and when the grayscale gk is equal to or greater than the predetermined grayscale gs, ΔV12(gk)=0V is set, and the relation ΔV12(gk)=ΔV12(gk+1) is satisfied.

Preferably, each of the pixels further includes a third sub-pixel which is different from the first sub-pixel and the second sub-pixel. When each of the pixels displays the grayscale gk, a voltage V3(gk) is applied to the liquid crystal layer of the third sub-pixel, and ΔV13(gk)=V1(gk)−V3(gk) is set, and when the grayscale gk is smaller than predetermined grayscale gs, ΔV13(gk)>0V is set, and the relation ΔV12(gk)<ΔV13(gk) is satisfied, and when the grayscale gk is equal to or greater than the predetermined grayscale gs, ΔV13(gk)=0V is set, and the relation ΔV12(gk)=ΔV13(gk) is satisfied.

Preferably, the first sub-pixel includes a first transistor electrically coupled to a first source line, and the second sub-pixel includes a second transistor electrically coupled to a second source line. The first source line and the second source line are parallel to each other and provide a voltage signal to the first sub-pixel and the second sub-pixel separately. The first transistor and the second transistor are electrically coupled to a gate line and provide the same scan signal to the first sub-pixel and the second sub-pixel.

Preferably, when the voltage V1(gk) is smaller than predetermined voltage Vs, ΔV12(gk)>0V is set, and the relation ΔV12(gk)=ΔV12(gk+1) is satisfied, when the voltage V1(gk) is equal to or greater than the predetermined voltage Vs, ΔV12(gk)=0V is set, and the relation ΔV12(gk)=ΔV12(gk+1) is satisfied.

Preferably, the highest-brightness grayscale n is 256 and the predetermined grayscale gs is 128.

Preferably, the pixels are array pixels.

In a preferred embodiment of the present invention, the liquid crystal display apparatus includes a liquid crystal layer. The liquid crystal layer is divided into a plurality of pixels and displayed in a normal-black manner. The plurality of pixels has a plurality of electrodes applying a voltage to the liquid crystal layer. Wherein each of the pixels includes a first sub-pixel and a second sub-pixel, and a voltage is applied to the liquid crystal layer of each pixel separately. When each of the pixels displays a grayscale gk, the voltages applied to the liquid crystal layer of the first sub-pixel and the second sub-pixel of each pixel are V1(gk) and V2(gk) respectively, ΔV12(gk)=V1(gk)−V2(gk) is set, wherein 0≤gk≤n, gk and n are integers greater than 0, and n stands for the highest-brightness grayscale, and when the grayscale gk is smaller than a predetermined grayscale gs, ΔV12(gk)>0V is set, and the relation ΔV12(gk)≥ΔV12(gk+1) is satisfied, and when the grayscale gk is equal to or greater than the predetermined grayscale gs, ΔV12(gk)=0V is set, and the relation ΔV12(gk)=ΔV12(gk+1) is satisfied.

Preferably, each of the pixels further includes a third sub-pixel which is different from the first sub-pixel and the second sub-pixel. When each of the pixels displays the grayscale gk, a voltage V3(gk) is applied to the liquid crystal layer of the third sub-pixel, and ΔV13(gk)=V1(gk)−V3(gk) is set, and when the grayscale gk is smaller than the predetermined grayscale gs, ΔV13(gk)>0V is set, and the relation ΔV12(gk)<ΔV13(gk) is satisfied, and when the grayscale gk is equal to or greater than the predetermined grayscale gs, ΔV13(gk)=0V is set, and the relation ΔV12(gk)=ΔV13(gk) is satisfied.

Preferably, the first sub-pixel includes a first transistor electrically coupled to a first source line. The second sub-pixel includes a second transistor electrically coupled to a second source line, and the first source line and the second source line are parallel to each other and provide a voltage signal to the first sub-pixel and the second sub-pixel separately. The first transistor and the second transistor are electrically coupled to a gate line and provide the same scan signal to the first sub-pixel and the second sub-pixel.

Preferably, when the voltage V1(gk) is smaller than the predetermined voltage Vs, ΔV12(gk)>0V is set, and the relation ΔV12(gk)≥ΔV12(gk+1) is satisfied, and when the voltage V1(gk) is equal to or greater than the predetermined voltage Vs, ΔV12(gk)=0V is set, and the relation ΔV12(gk)=ΔV12(gk+1) is satisfied.

Preferably, the highest-brightness grayscale n is 256 and the predetermined grayscale gs is 128.

In preferred embodiment of the present invention, a method for driving a liquid crystal display apparatus is disclosed, wherein a liquid crystal display apparatus includes a liquid crystal layer which is divided into a plurality of pixels. Each pixel includes a first sub-pixel and a second sub-pixel, and the pixels have a plurality of electrodes applying a voltage to the liquid crystal layer. The method for driving the liquid crystal display apparatus includes the following steps: when each of the pixels displays a grayscale gk, a voltage V1(gk) is applied to the first sub-pixel, and a voltage V2(gk) is applied to the second sub-pixel, and ΔV12(gk)=V1(gk)−V2(gk) is set, wherein, 0≤gk≤n, and gk and n are integers greater than 0, and n stands for the highest-brightness grayscale; when the grayscale gk is smaller than the predetermined grayscale gs, the voltage V1(gk) and voltage V2(gk) are applied, such that ΔV12(gk)>0V, and the relation ΔV12(gk)>ΔV12(gk+1) is satisfied; when the grayscale gk is equal to or greater than the predetermined grayscale gs, V1(gk)=V2(gk) is set, such that ΔV12(gk)=0V, and the relation ΔV12(gk)=ΔV12(gk+1) is satisfied.

Preferably, the method for driving the liquid crystal display apparatus further includes the following steps: when a voltage V3(gk) is applied to a third sub-pixel which is different from the first sub-pixel and the second sub-pixel on the liquid crystal layer, ΔV13(gk)=V1(gk)−V3(gk) is set; when the grayscale gk is smaller than the predetermined grayscale gs, the voltage V1(gk) and voltage V3(gk) are applied, such that ΔV13(gk)>0V, and the relation ΔV12(gk)<ΔV13(gk) is satisfied; and when the grayscale gk is equal to or greater than the predetermined grayscale gs, V1(gk)=V3(gk) is set, such that ΔV13(gk)=0V, and the relation ΔV12(gk)=ΔV13(gk) is satisfied.

Preferably, the method for driving the liquid crystal display apparatus further includes the following steps: a first source line and a second source line provide a voltage signal to the first sub-pixel and the second sub-pixel separately; and a gate line provides a same scan signal to the first sub-pixel and the second sub-pixel.

Preferably, when the voltage V1(gk) is smaller than predetermined voltage Vs, the voltage V1(gk) and voltage V2(gk) are applied, such that ΔV12(gk)>0V, and the relation ΔV12(gk)>ΔV12(gk+1) is satisfied; when the voltage V1(gk) is equal to or greater than the predetermined voltage Vs, V1(gk)=V2(gk) is set, such that ΔV12(gk)=0V, and the relation ΔV12(gk)=ΔV12(gk+1) is satisfied.

Preferably, the highest-brightness grayscale n is 256 and the predetermined grayscale gs is 128.

Preferably, the pixels are array pixels.

In a preferred embodiment of the present invention, a method for driving a liquid crystal display apparatus is disclosed, wherein a liquid crystal display apparatus includes a liquid crystal layer which is divided into a plurality of pixels. Each pixel includes a first sub-pixel and a second sub-pixel, and the pixels have a plurality of electrodes applying a voltage to the liquid crystal layer. The method for driving the liquid crystal display apparatus, includes the following steps: when each of the pixels displays the grayscale gk, a voltage V1(gk) is applied to the first sub-pixel and a voltage V2(gk) is applied to the second sub-pixel, and ΔV12(gk)=V1(gk)−V2(gk) is set, wherein, 0≤gk≤n, and gk and n are integers greater than 0, and n stands for the highest-brightness grayscale; when the grayscale gk is smaller than a predetermined grayscale gs, the voltage V1(gk) and voltage V2(gk) are applied, such that ΔV12(gk)>0V, and the relation ΔV12(gk)=ΔV12(gk+1) is satisfied; and when the grayscale gk is equal to or greater than the predetermined grayscale gs, V1(gk)=V2(gk) is set, such that ΔV12(gk)=0V, and the relation ΔV12(gk)=ΔV12(gk+1) is satisfied.

Preferably, the method for driving the liquid crystal display apparatus further includes the following steps: a voltage V3(gk) is applied to a third sub-pixel which is different from the first sub-pixel and the second sub-pixel on the liquid crystal layer, and ΔV13(gk)=V1(gk)−V3(gk) is set; when the grayscale gk is smaller than the predetermined grayscale gs, the voltage V1(gk) and voltage V3(gk) are applied, such that ΔV13(gk)>0V, and the relation ΔV12(gk)>ΔV13(gk) is satisfied; and when the grayscale gk is equal to or greater than the predetermined grayscale gs, V1(gk)=V3(gk) is set, such that ΔV13(gk)=0V, and the relation ΔV12(gk)=ΔV13(gk) is satisfied.

Preferably, liquid crystal display apparatus driving method further includes the following steps: a first source line and a second source line provide a voltage signal to the first sub-pixel and the second sub-pixel separately; and a gate line provides the same scan signal to the first sub-pixel and the second sub-pixel

Preferably, when the voltage V1(gk) is smaller than predetermined voltage Vs, the voltage V1(gk) and voltage V2(gk) are applied, such that ΔV12(gk)>0V, and the relation ΔV12(gk)=ΔV12(gk+1) is satisfied; and when the voltage V1(gk) is equal to or greater than the predetermined voltage Vs, V1(gk)=V2(gk) is set, such that ΔV12(gk)=0V, and the relation ΔV12(gk)=ΔV12(gk+1) is satisfied.

Preferably, the highest-brightness grayscale n is 256 and the predetermined grayscale gs is 128.

Preferably, the pixels are array pixels.

In a preferred embodiment of the present invention, a method for driving a liquid crystal display apparatus is disclosed, wherein a liquid crystal display apparatus includes a liquid crystal layer which is divided into a plurality of pixels. Each pixel includes a first sub-pixel and a second sub-pixel, and the pixels have a plurality of electrodes applying a voltage to the liquid crystal layer; and the method for driving the liquid crystal display apparatus, includes the following steps: when each of the pixels displays the grayscale gk, a voltage V1(gk) is applied to the first sub-pixel and a voltage V2(gk) is applied to the second sub-pixel, and ΔV12(gk)=V1(gk)−V2(gk) is set, wherein, 0≤gk≤n, and gk and n are integers greater than 0, and n stands for the highest-brightness grayscale; when the grayscale gk is smaller than a predetermined grayscale gs, the voltage V1(gk) and voltage V2(gk) are applied, such that ΔV12(gk)>0V, and the relation ΔV12(gk)≥ΔV12(gk+1) is satisfied; and when the grayscale gk is equal to or greater than the predetermined grayscale gs, V1(gk)=V2(gk) is set, such that ΔV12(gk)=0V, and the relation ΔV12(gk)=ΔV12(gk+1) is satisfied.

Preferably, the method for driving the liquid crystal display apparatus further includes the following steps: a voltage V3(gk) is applied to a third sub-pixel which is different from the first sub-pixel and the second sub-pixel on the liquid crystal layer, and ΔV13(gk)=V1(gk)−V3(gk) is set; when the grayscale gk is smaller than the predetermined grayscale gs, the voltage V1(gk) and voltage V3(gk) are applied, such that ΔV13(gk)>0V, and the relation ΔV12(gk)>ΔV13(gk) is satisfied; and when the grayscale gk is equal to or greater than the predetermined grayscale gs, V1(gk)=V3(gk) is set, such that ΔV13(gk)=0V, and the relation ΔV12(gk)=ΔV13(gk) is satisfied.

Preferably, the method for driving the liquid crystal display apparatus further includes the following steps: a first source line and a second source line provide a voltage signal to the first sub-pixel and the second sub-pixel separately; and a gate line provides a same scan signal to the first sub-pixel and the second sub-pixel.

Preferably, when the voltage V1(gk) is smaller than predetermined voltage Vs, the voltage V1(gk) and the voltage V2(gk) are applied, such that ΔV12(gk)>0V, and the relation ΔV12(gk)>ΔV12(gk+1) is satisfied; when the voltage V1(gk) is equal to or greater than the predetermined voltage Vs, V1(gk)=V2(gk) is set, such that ΔV12(gk)=0V, and the relation ΔV12(gk)=ΔV12(gk+1) is satisfied.

Preferably, the highest-brightness grayscale n is 256 and the predetermined grayscale gs is 128.

In summation, the present invention provides a liquid crystal display apparatus and its driving method. Wherein a voltage is applied to the sub-pixels separately to improve the γ characteristic of different viewing angles of the liquid crystal display apparatus and the display quality. In addition, the present invention provides different conditions for applying the voltage when displaying different grayscales, so as to improve the driving process and the drive efficiency of the liquid crystal display apparatus.

### BRIEF DESCRIPTION OF THE DRAWINGS

The above and other objects, features and advantages of this disclosure will become apparent from the following detailed description taken with the accompanying drawings. It is noteworthy that the drawings are provided for the purpose of illustrating the invention and other drawings may be obtained without any creative labor by persons having ordinary skill in the art.

FIG. 1 is a schematic view of a liquid crystal display apparatus in accordance with a preferred embodiment of the present invention;

FIG. 2 is a schematic view showing a type of pixels of a liquid crystal display apparatus in accordance with a preferred embodiment of the present invention;

FIGS. 3A and 3B are schematic views showing a status of applying a voltage in accordance with a preferred embodiment of the present invention;

FIG. 4 is a schematic view showing another type of pixels of a liquid crystal display apparatus in accordance with a preferred embodiment of the present invention;

FIG. 5 is a flow chart of a method for driving a liquid crystal display apparatus in accordance with a preferred embodiment of the present invention;

FIGS. 6A and 6B are schematic views showing another status of applying a voltage in accordance with a preferred embodiment of the present invention;

FIG. 7 is a flow chart of another liquid crystal display apparatus driving method in accordance with a preferred embodiment of the present invention;

FIGS. 8A and 8B are schematic views showing a further status of applying a voltage in accordance with a preferred embodiment of the present invention; and

FIG. 9 is a flow chart of another further liquid crystal display apparatus driving method in accordance with a preferred embodiment of the present invention.

### DESCRIPTION OF THE PREFERRED EMBODIMENTS

It is noteworthy that the embodiments are provided for the purpose of illustrating the present invention, but not intended for limiting the scope of the invention.

It is noteworthy that this specification uses an open-ended term “including” meaning that the claim encompasses all the elements listed, but may also include additional unnamed elements.

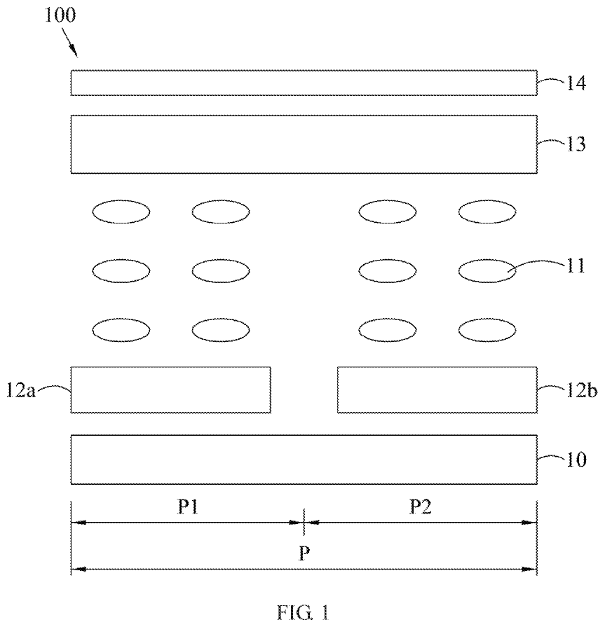

With reference to FIG. 1 for a schematic view of a liquid crystal display apparatus in accordance with a preferred embodiment of the present invention, the liquid crystal display apparatus 100 includes a plurality of pixels P arranged in an array, and each pixel P has a liquid crystal layer 11 disposed on a substrate 10, wherein the liquid crystal display apparatus 100 displays in a normal-black manner. The liquid crystal layer 11 forms an electric field, by a pixel electrode and a common electrode 13 to change the twisted direction of liquid crystal molecules, so as to change the transmittance of the liquid crystal display apparatus 100. Wherein, the pixel electrode includes a first electrode 12a and a second electrode 12b installed between the substrate 10 and the liquid crystal layer 11, and the first electrode 12a and common electrode 13 apply a voltage to a first sub-pixel P1 of the pixel P, and the second electrode 12b and common electrode 13 apply a voltage to a second sub-pixel P2 of the pixel P. Since the first electrode 12a and second electrode 12b can apply different voltages, therefore the liquid crystal of different sub-pixels in each pixel P can be controlled to have different levels of twisting. For different viewing angles, the γ characteristic of the liquid crystal display apparatus 100 can be improved.

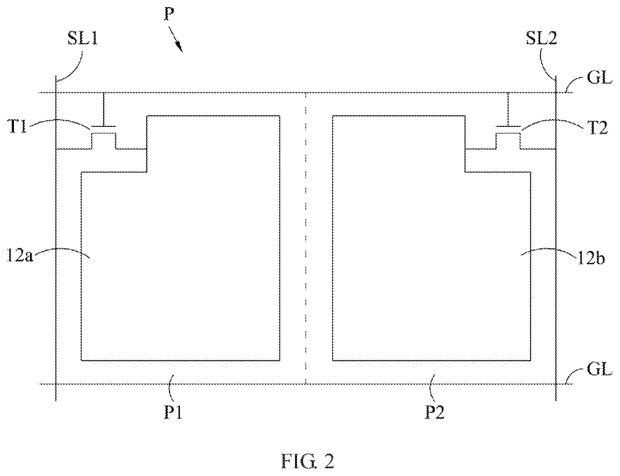

With reference to FIG. 2 for a schematic view showing a pixel of a liquid crystal display apparatus in accordance with a preferred embodiment of the present invention, the liquid crystal display apparatus uses a parallel gate line and a parallel source line to form a plurality of array pixels P, and the area of each pixel P may be divided into a first sub-pixel P1 and a second sub-pixel P2. Wherein, the first sub-pixel P1 includes a first electrode 12a and a first transistor T1, and the first electrode 12a is electrically coupled to a first source line SL1 through the first transistor T1, and the second sub-pixel P2 includes a second electrode 12b and a second transistor T2, and the second electrode 12b is electrically coupled to a second source line SL2 through the second transistor T2, and the first source line SL1 and the second source line SL2 are parallel to each other and provide a voltage signal to the first sub-pixel P1 and second sub-pixel P2 separately. In addition, the first transistor T1 and the second transistor T2 are electrically coupled to a same gate line GL, and the gate line GL provides a same scan signal to the first sub-pixel P1 and the second sub-pixel P2. When each pixel P needs to display a specific grayscale, a control chip of the gate line and source line is connected to send a same scan signal to the pixel P through the gate line GL, and the respective voltage signals by the first source line SL1 and the second source line SL2 respectively, so that the first electrode 12a and the second electrode 12b can apply different voltages to the liquid crystal layers of the pixels respectively.

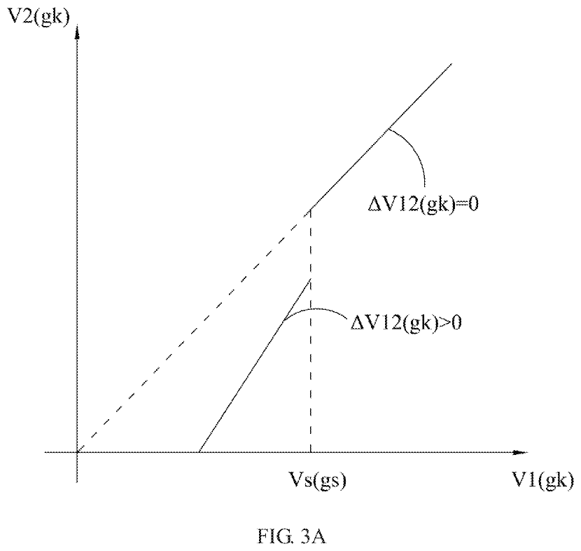

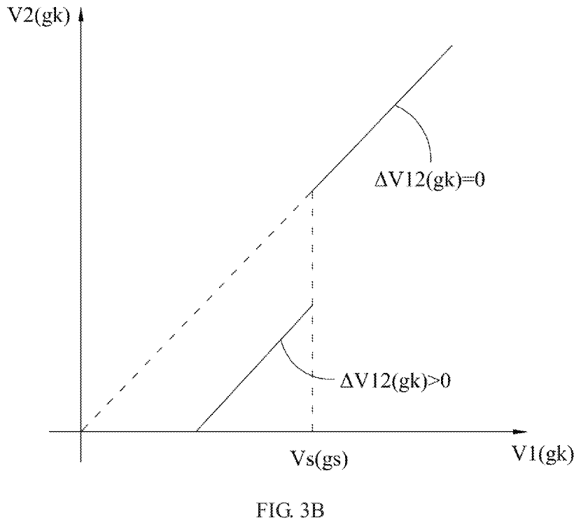

With reference to FIGS. 3A and 3B for the schematic views showing a status of applying a voltage in accordance with a preferred embodiment of the present invention, FIG. 3A shows that the horizontal axis represents the first voltage V1(gk) applied to the first pixel, and the vertical axis represents the second voltage V2(gk) applied to the second pixel, and a voltage difference ΔV12(gk)=V1(gk)−V2(gk) is set, wherein 0≤gk≤n, and gk and n are integers greater than 0, and gk is the grayscale of the pixel displayed by the liquid crystal display apparatus, and n stands for the highest-brightness grayscale. For example, n is 256. The status of applying the first voltage V1(gk) and second voltage V2(gk) is shown in the figure. When the grayscale gk is smaller than a predetermined grayscale gs, ΔV12(gk)>0V is set, and the relation ΔV12(gk)>ΔV12(gk+1) is satisfied. In other words, when the grayscale gk is between 0 and gs, the first voltage V1(gk) is greater than second voltage V2(gk). When the grayscale gk is increased, the voltage difference ΔV12(gk) between the first voltage V1(gk) and the second voltage V2(gk) drops gradually. When the grayscale gk is equal to or greater than predetermined grayscale gs, ΔV12(gk)=0V is set, and the relation ΔV12(gk)=ΔV12(gk+1) is satisfied. In other words, when the grayscale gk is between gs and n, the first voltage V1(gk) is controlled to be equal to the second voltage V2(gk), so that the voltage difference ΔV12(gk) between the first voltage V1(gk) and the second voltage V2(gk) is 0. When the grayscale gk is increased, the voltage difference ΔV12(gk) between the first voltage V1(gk) and the second voltage V2(gk) remains unchanged.

In FIG. 3B, the horizontal axis represents the first voltage V1(gk) applied to the first pixel, and the vertical axis represents the second voltage V2(gk) applied to the second pixel, and a voltage difference ΔV12(gk)=V1(gk)−V2(gk) is set, wherein 0≤gk≤n, and gk and n are integers greater than 0, and gk is the grayscale of the pixel displayed by the liquid crystal display apparatus, and n stands for the highest-brightness grayscale. For example, n is 256. The status of applying the first voltage V1(gk) and second voltage V2(gk) is shown in the figure. When the grayscale gk is smaller than a predetermined grayscale gs, ΔV12(gk)>0V is set, and the relation ΔV12(gk)=ΔV12(gk+1) is satisfied. In other words, when the grayscale gk is between 0 and gs, the first voltage V1(gk) is greater than second voltage V2(gk). When the grayscale gk is increased, the voltage difference ΔV12(gk) between the first voltage V1(gk) and the second voltage V2(gk) remains unchanged. When the grayscale gk is equal to or greater than predetermined grayscale gs, ΔV12(gk)=0V is set, and the relation ΔV12(gk)=ΔV12(gk+1) is satisfied, In other words, when the grayscale gk is between gs and n, the first voltage V1(gk) is controlled to be equal to the second voltage V2(gk), such that the voltage difference ΔV12(gk) between the first voltage V1(gk) and the second voltage V2(gk) is 0. When the grayscale gk is increased, the voltage difference ΔV12(gk) between the first voltage V1(gk) and the second voltage V2(gk) remains unchanged.

Since the transmittance of the liquid crystal display apparatus increases with the voltage, therefore the predetermined grayscale gs can be determined by its corresponding applied voltage. For example, if the applied first voltage V1(gk) reaches a voltage value Vs(gs) of the predetermined grayscale gs, then the status of applying a voltage as shown in FIGS. 3A and 3B may be used to control the liquid crystal display apparatus. The first voltage applied to the first sub-pixel and the second voltage applied to the second sub-pixel can be controlled, so that when the grayscale is low, an appropriate voltage difference is provided to improve the γ characteristic of different viewing angles of the liquid crystal display apparatus. When the displayed grayscale reaches the predetermined grayscale (such as when the predetermined grayscale gs is greater than 128), the voltage applied to the first sub-pixel and the voltage applied to the second sub-pixel are equal, so that the use of the control program for switching different voltage signals can be reduced to improve the drive efficiency of the liquid crystal display apparatus.

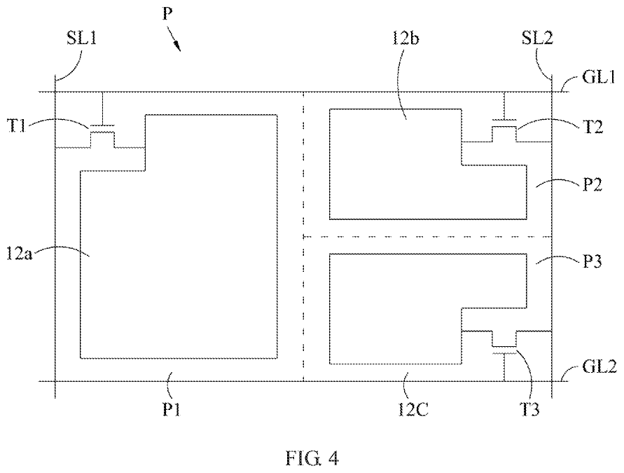

With reference to FIG. 4 for a schematic view showing another type of pixels of a liquid crystal display apparatus in accordance with a preferred embodiment of the present invention, the liquid crystal display apparatus uses a parallel gate line and a parallel source line to form a plurality of array pixels P, and the area of each pixel P may be divided into a first sub-pixel P1, a second sub-pixel P2, and a third sub-pixel P3. Wherein, the first sub-pixel P1 includes a first electrode 12a and a first transistor T1, and the first electrode 12a is electrically coupled to a first source line SL1 through the first transistor T1, and the second sub-pixel P2 includes a second electrode 12b and a second transistor T2, and the second electrode 12b is electrically coupled to a second source line SL2 through the second transistor T2, and the third sub-pixel P3 includes a third electrode 12c and a third transistor T3, and the third electrode 12c is electrically coupled to the second source line SL2 through a third transistor T3, and the first source line SL1 and the second source line SL2 are parallel to each other, and the first source line SL1 provides a voltage signal to the first sub-pixel P1, and the second source line SL2 provides a voltage signal to the second sub-pixel P2. In addition, the first transistor T1 and the second transistor T2 are electrically coupled to a first gate line GL1, and the first gate line GL1 provides a same scan signal to the first sub-pixel P1 and the second sub-pixel P2, and the third transistor T3 is electrically coupled to the second gate line GL2, and the second gate line GL2 provides a scan signal to the third sub-pixel P3. When each pixel P needs to display a specific grayscale, a control chip of the gate line and the source line is connected to send a scan signal to the pixel P through the first gate line GL1 and the second gate line GL2, and also send a voltage signal to the first source line SL1 and the second source line SL2 separately, so that the first electrode 12a, second electrode 12b and third electrode 12c can apply different voltages to the liquid crystal layers of the pixels respectively.

In the foregoing preferred embodiment, the pixel is divided into three sub-pixels, wherein the voltage applied to the third sub-pixel P3 is V3(gk), and the voltage difference ΔV13(gk)=V1(gk)−V3(gk) between the first sub-pixel P1 and the third sub-pixel is set. Wherein, when the grayscale gk is smaller than a predetermined grayscale gs, ΔV13(gk)>0V is set, and the relation ΔV12(gk)>ΔV13(gk) is satisfied. In other words, when the grayscale gk is between 0 and gs, the first voltage V1(gk) is greater than the third voltage V2(gk). In the meantime, the voltage difference ΔV12(gk) between the first voltage V1(gk) and the second voltage V2(gk) is greater than the voltage difference ΔV13(gk) between the first sub-pixel P1 and the third sub-pixel. When the grayscale gk is equal to or greater than the predetermined grayscale gs, ΔV13(gk)=0V is set, and the relation ΔV12(gk)=ΔV13(gk) is satisfied. In other words, when the grayscale gk is between gs and n, the first voltage V1(gk) is controlled to be equal to the third voltage V3(gk), such that ΔV13(gk)=0. When the grayscale gk is increased, the voltage difference between the ΔV12(gk) and the ΔV13(gk) is 0. The aforementioned way of dividing the pixel into sub-pixels can divide the second sub-pixel P2 and the third sub-pixel P3 with the same area, but the present invention is not limited to such arrangement only, and each pixel may be divided into three or more sub-pixels, and the area occupied by each sub-pixel may be designed according to the quantity of divisions. The more the divided sub-pixels, the more the control circuits, in order to provide different voltages. Therefore, appropriate quantity and positions of the divided sub-pixels can be used for the divided sub-pixels to meet the required display quality of the liquid crystal display apparatus.

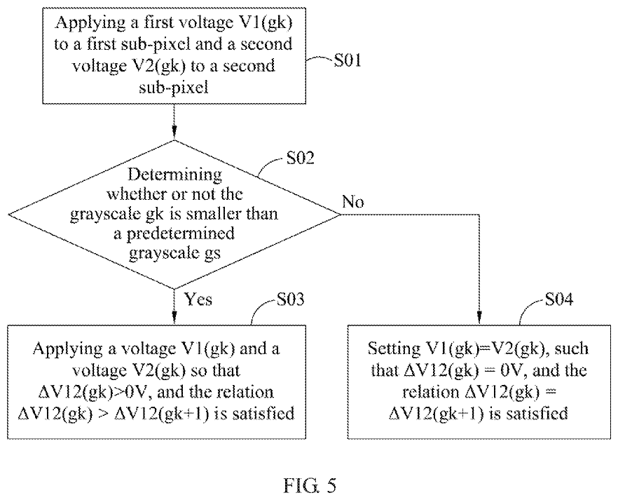

With reference to FIG. 5 a flow chart of a method for driving a liquid crystal display apparatus in accordance with a preferred embodiment of the present invention, the method for driving the liquid crystal display apparatus is applicable for the liquid crystal display apparatus as shown in FIGS. 1 and 2, and the liquid crystal display apparatus includes a liquid crystal layer 11, and each pixel P includes a first sub-pixel P1 and a second sub-pixel P2, and a first source line SL1 and a second source line SL2 provide a voltage signal to the first sub-pixel P1 and the second sub-pixel P2 separately, and a same scan signal is provided to the first sub-pixel P1 and the second sub-pixel P2 through the gate line GL, and a voltage is applied to the first pixel P1 on the liquid crystal layer 11 through the first electrode 12a and a voltage is applied to the second pixel P2 on the liquid crystal layer 11 through the second electrode 12b. The method for driving the liquid crystal display apparatus includes the following steps (S01-S04):

Step S01: Applying a first voltage V1(gk) to a first sub-pixel and a second voltage V2(gk) to a second sub-pixel.

Step S02: Determining whether or not the grayscale gk is smaller than a predetermined grayscale gs. Like the previous preferred embodiment, Step S02 determines whether or not the grayscale is smaller than the predetermined grayscale gs or making the determination by comparing if the applied first voltage V1(gk) has reached a voltage value Vs(gs) of the predetermined grayscale gs.

If yes, then go to Step S03: Applying a voltage V1(gk) and a voltage V2(gk) so that ΔV12(gk)>0V, and the relation ΔV12(gk)>ΔV12(gk+1) is satisfied.

If no, then go to Step S04: Setting V1(gk)=V2(gk), such that ΔV12(gk)=0V, and the relation ΔV12(gk)=ΔV12(gk+1) is satisfied.

The aforementioned step may be executed according to the voltage control status as shown in FIG. 3A. If so, Step S03 satisfies the relation ΔV12(gk)=ΔV12(gk+1). In addition, if the pixel is divided into three or more sub-pixels, the voltage control as described in Steps S03 and S04 and illustrated in FIG. 4 has to add the voltage control of the third sub-pixel. For example, Step S03 further applies a third voltage V3(gk) to the third sub-pixel in addition to applying the first voltage V1(gk) and second voltage V2(gk) to the first sub-pixel and the second sub-pixel respectively, and ΔV13(gk)>0V, and the relation ΔV12(gk)>ΔV13(gk) is satisfied. In Step S04, V1(gk)=V3(gk) is set, so that ΔV13(gk)=0V, and the relation ΔV12(gk)=ΔV13(gk) is satisfied.

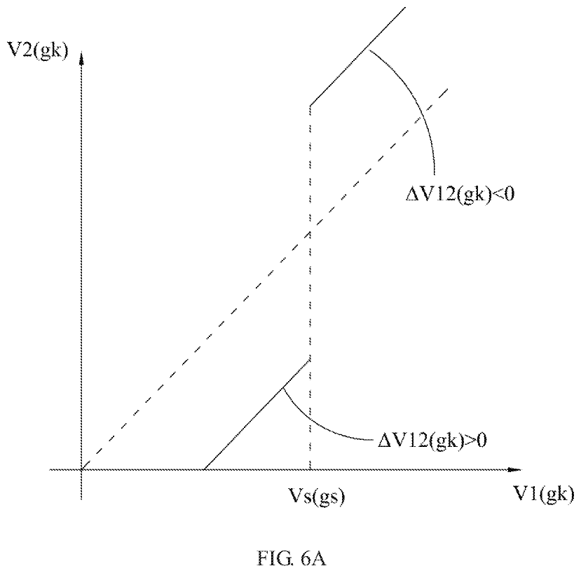

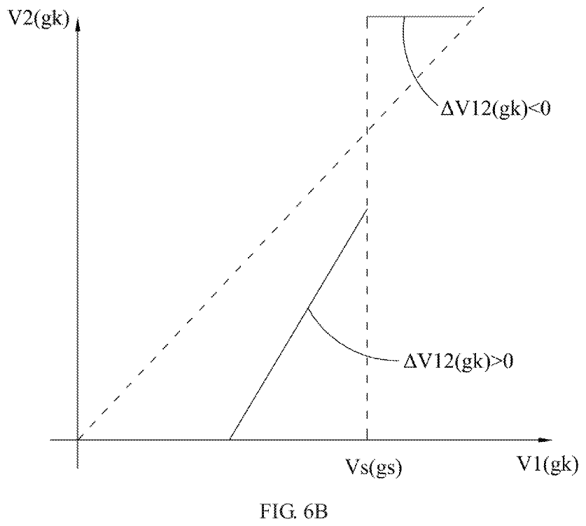

With reference to FIGS. 6A and 6B for the schematic views showing another status of applying a voltage in accordance with a preferred embodiment of the present invention, FIG. 6A shows that the horizontal axis represents the first voltage V1(gk) applied to the first pixel, and the vertical axis represents the second voltage V2(gk) applied to the second pixel, and a voltage difference ΔV12(gk)=V1(gk)−V2(gk) is set, wherein 0≤gk≤n, and gk and n are integers greater than 0, and gk is the grayscale of the pixel displayed by the liquid crystal display apparatus, and n stands for the highest-brightness grayscale. For example, n is 256. The status of applying the first voltage V1(gk) and second voltage V2(gk) is shown in the figure. When the grayscale gk is smaller than predetermined grayscale gs, ΔV12(gk)>0V is set, and the relation ΔV12(gk)>ΔV12(gk+1) is satisfied. In other words, when the grayscale gk is between 0 and gs, the first voltage V1(gk) is greater than the second voltage V2(gk). When the grayscale gk is increased, the voltage difference ΔV12(gk) between the first voltage V1(gk) and the second voltage V2(gk) drops gradually. When the grayscale gk is equal to or greater than the predetermined grayscale gs, ΔV12(gk)<0V is set, and the relation ΔV12(gk)<ΔV12(gk+1) is satisfied. In other words, when the grayscale gk is between gs and n, the first voltage V1(gk) is controlled to be smaller than the second voltage V2(gk), so that the voltage difference ΔV12(gk) between the first voltage V1(gk) and the second voltage V2(gk) smaller than 0. When the grayscale gk is increased, the voltage difference ΔV12(gk) between the first voltage V1(gk) and the second voltage V2(gk) increases gradually.

In FIG. 6B, the horizontal axis represents the first voltage V1(gk) applied to the first pixel, and the vertical axis represents the second voltage V2(gk) applied to the second pixel, and a voltage difference ΔV12(gk)=V1(gk)−V2(gk) is set, wherein 0≤gk≤n, and gk and n are integers greater than 0, and gk is the grayscale of the pixel displayed by the liquid crystal display apparatus, and n stands for the highest-brightness grayscale. For example, n is 256. The status of applying the first voltage V1(gk) and second voltage V2(gk) is shown in the figure. When the grayscale gk is smaller than a predetermined grayscale gs, ΔV12(gk)>0V is set, and the relation ΔV12(gk)=ΔV12(gk+1) is satisfied. In other words, when the grayscale gk is between 0 and gs, the first voltage V1(gk) is greater than second voltage V2(gk). When the grayscale gk is increased, the voltage difference ΔV12(gk) between the first voltage V1(gk) and the second voltage V2(gk) remain unchanged. When the grayscale gk is equal to or greater than the predetermined grayscale gs, ΔV12(gk)<0V is set, and the relation ΔV12(gk)=ΔV12(gk+1) is satisfied. In other words, when the grayscale gk is between gs and n, the first voltage V1(gk) is controlled to be smaller than the second voltage V2(gk), so that the voltage difference ΔV12(gk) between the first voltage V1(gk) and the second voltage V2(gk) is smaller than 0. When the grayscale gk is increased, the voltage difference ΔV12(gk) between the first voltage V1(gk) and the second voltage V2(gk) remains unchanged.

Since the transmittance of the liquid crystal display apparatus increases with the voltage, therefore the predetermined grayscale gs can be determined by its corresponding applied voltage. For example, if the applied first voltage V1(gk) reaches a voltage value Vs(gs) of the predetermined grayscale gs, then the status of applying a voltage as shown in FIGS. 6A and 6B may be used to control the liquid crystal display apparatus. With the aforementioned method, the first voltage applied to the first sub-pixel and the second voltage applied to the second sub-pixel can be controlled, so that when the grayscale is low, an appropriate voltage difference is provided to improve the γ characteristic of different viewing angles of the liquid crystal display apparatus. When the displayed grayscale reaches the predetermined grayscale (such as when the predetermined grayscale gs is greater than 128), the voltage applied to the first sub-pixel is smaller than or equal to the voltage applied to the second sub-pixel. By changing the status of applying the voltage, the display effect of the liquid crystal display apparatus can be improved.

If the pixel of the liquid crystal display apparatus is divided into three sub-pixels as shown in FIG. 4, a third voltage is applied to the third sub-pixel in addition to applying the first voltage V1(gk) and second voltage V2(gk) to the first sub-pixel and the second sub-pixel respectively. When the grayscale gk is smaller than the predetermined grayscale gs, the relations ΔV13(gk)>0V and ΔV12(gk)>ΔV13(gk) are satisfied. When the grayscale gk is equal to or greater than the predetermined grayscale gs, the relations ΔV13(gk)<0V, and ΔV12(gk)=ΔV13(gk) are satisfied.

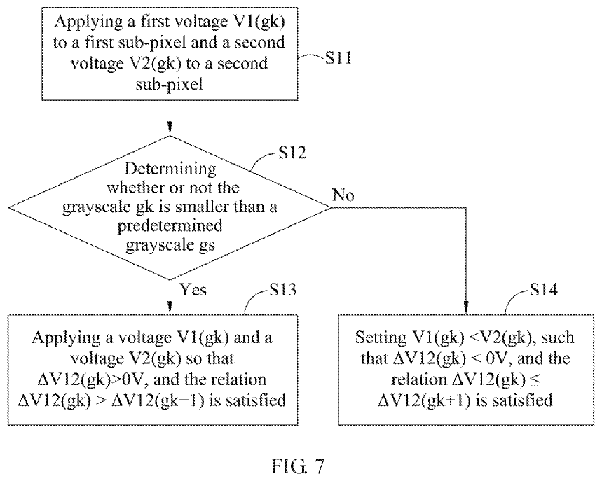

With reference to FIG. 7 for a flow chart of another liquid crystal display apparatus driving method in accordance with a preferred embodiment of the present invention, the method for driving the liquid crystal display apparatus is applicable for the liquid crystal display apparatus as shown in FIGS. 1 and 2, and the liquid crystal display apparatus includes a liquid crystal layer 11, and each pixel P includes a first sub-pixel P1 and a second sub-pixel P2, and a first source line SL1 and a second source line SL2 provide a voltage signal to the first sub-pixel P1 and the second sub-pixel P2 separately, and a same scan signal is provided to the first sub-pixel P1 and the second sub-pixel P2 through the gate line GL, and a voltage is applied to the first pixel P1 on the liquid crystal layer 11 through the first electrode 12a and a voltage is applied to the second pixel P2 on the liquid crystal layer 11 through the second electrode 12b. The method for driving the liquid crystal display apparatus includes the following steps (S11-S14):

Step S11: Applying a first voltage V1(gk) to a first sub-pixel and a second voltage V2(gk) to a second sub-pixel.

Step S12: Determining whether or not the grayscale gk is smaller than a predetermined grayscale gs. Like the previous preferred embodiment, Step S12 determines whether or not the grayscale is smaller than the predetermined grayscale gs or making the determination by comparing if the applied first voltage V1(gk) has reached a voltage value Vs(gs) of the predetermined grayscale gs.

If yes, go to Step S13: Applying a voltage V1(gk) and a voltage V2(gk) so that ΔV12(gk)>0V, and the relation ΔV12(gk)>ΔV12(gk+1) is satisfied.

If no, go to Step S14: Setting V1(gk)<V2(gk), such that ΔV12(gk)<0V, and the relation ΔV12(gk)<ΔV12(gk+1) is satisfied.

The aforementioned step is executed by referring to the voltage control status as illustrated in FIG. 6A. If so, Step S13 satisfies the relation ΔV12(gk)=ΔV12(gk+1) and Step S14 satisfies the relation ΔV12(gk)=ΔV12(gk+1). If addition, if the pixel is divided into three or more sub-pixels, the voltage control as described in Steps S13 and S14 has to add the voltage control of the third sub-pixel. When the grayscale gk is smaller than the predetermined grayscale gs, the voltage V1(gk) and voltage V3(gk) are applied, and ΔV13(gk)>0V is set, and the relationΔV12(gk)<ΔV13(gk) is satisfied. When the grayscale gk is equal to or greater than the predetermined grayscale gs, V1(gk)<V3(gk) is set, such that ΔV13(gk)<0V, and the relation ΔV12(gk)=ΔV13(gk) is satisfied.

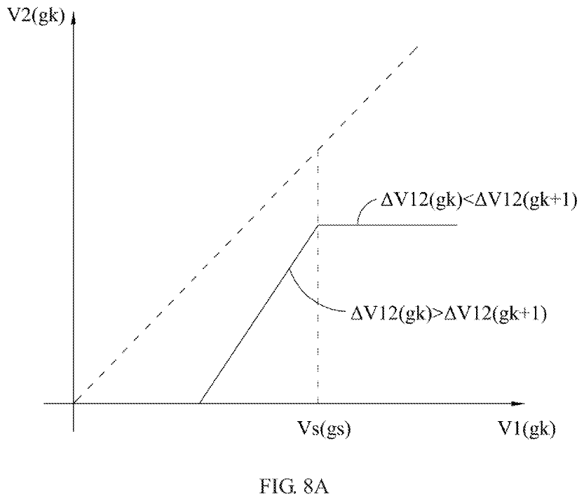

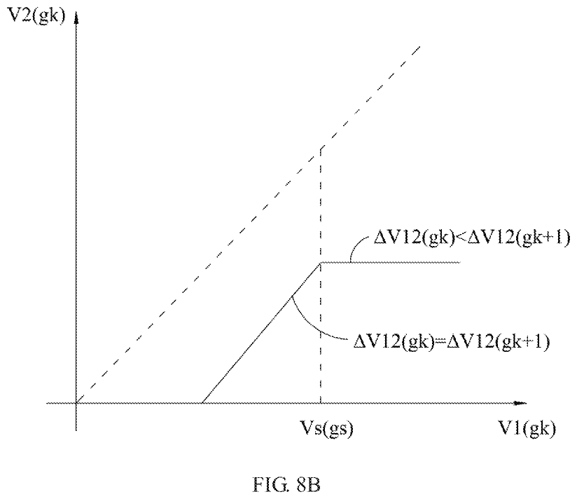

With reference to FIGS. 8A and 8B for the schematic views showing a further status of applying a voltage in accordance with a preferred embodiment of the present invention, FIG. 8A shows that the horizontal axis represents the first voltage V1(gk) applied to the first pixel, and the vertical axis represents the second voltage V2(gk) applied to the second pixel, and a voltage difference ΔV12(gk)=V1(gk)−V2(gk) is set, wherein 0≥gk≥n, and gk and n are integers greater than 0, and gk is the grayscale of the pixel displayed by the liquid crystal display apparatus, and n stands for the highest-brightness grayscale. For example, n is 256. The status of applying the first voltage V1(gk) and second voltage V2(gk) is shown in the figure. When the grayscale gk is smaller than predetermined grayscale gs, ΔV12(gk)>0V is set, and the relation ΔV12(gk)>ΔV12(gk+1) is satisfied. In other words, when the grayscale gk is between 0 and gs, the first voltage V1(gk) is greater than second voltage V2(gk). In the meantime, the grayscale gk is increased, the voltage difference ΔV12(gk) between the first voltage V1(gk) and the second voltage V2(gk) drops gradually. When the grayscale gk is equal to or greater than predetermined grayscale gs, ΔV12(gk)<0V is set, and the relation ΔV12(gk)≤ΔV12(gk+1) is satisfied. In other words, when the grayscale gk is between gs and n, the second voltage V2(gk) is controlled to remain unchanged, and the voltage difference ΔV12(gk) between the first voltage V1(gk) and the second voltage V2(gk) is greater than 0. When the grayscale gk is increased, the voltage difference ΔV12(gk) between the first voltage V1(gk) and the second voltage V2(gk) drops gradually.

In FIG. 8b, the horizontal axis represents the first voltage V1(gk) applied to the first pixel, and the vertical axis represents the second voltage V2(gk) applied to the second pixel, and a voltage difference ΔV12(gk)=V1(gk)−V2(gk) is set, wherein 0≤gk≤n, and gk and n are integers greater than 0, and gk is the grayscale of the pixel displayed by the liquid crystal display apparatus, and n stands for the highest-brightness grayscale. For example, n is 256. The status of applying the first voltage V1(gk) and second voltage V2(gk) is shown in the figure. When the grayscale gk is smaller than predetermined grayscale gs, ΔV12(gk)>0V is set, and the relation ΔV12(gk)=ΔV12(gk+1) is satisfied. In other words, when the grayscale gk is between 0 and gs, the first voltage V1(gk) is greater than second voltage V2(gk). In the meantime, when the grayscale gk is increased, the voltage difference ΔV12(gk) between the first voltage V1(gk) and the second voltage V2(gk) remains unchanged. When the grayscale gk is equal to or greater than predetermined grayscale gs, ΔV12(gk)>0V is set, and the relation ΔV12(gk)<ΔV12(gk+1) is satisfied. In other words, when the grayscale gk is between gs and n, the second voltage V2(gk) is controlled to remain unchanged, and the voltage difference ΔV12(gk) between the first voltage V1(gk) and the second voltage V2(gk) is greater than 0. When the grayscale gk is increased, the voltage difference ΔV12(gk) between the first voltage V1(gk) and the second voltage V2(gk) drops gradually.

Since the transmittance of the liquid crystal display apparatus increases with the voltage, therefore the predetermined grayscale gs can be determined by its corresponding applied voltage. For example, if the applied first voltage V1(gk) reaches a voltage value Vs(gs) of the predetermined grayscale gs, then the status of applying a voltage as shown in FIGS. 8A and 8B may be used to control the liquid crystal display apparatus. With the aforementioned method, the first voltage applied to the first sub-pixel and the second voltage applied to the second sub-pixel can be controlled, so that when the grayscale is low, an appropriate voltage difference is provided to improve the γ characteristic of different viewing angles of the liquid crystal display apparatus. When the displayed grayscale reaches the predetermined grayscale (such as when the predetermined grayscale gs is greater than 128), the voltage applied to the second sub-pixel remains unchanged, and just the voltage applied to the first sub-pixel is used to adjust the display status, so as to improve the convenience of the liquid crystal display apparatus and maintain an excellent display effect.

If a pixel of the liquid crystal display apparatus is divided into three sub-pixels as shown in FIG. 4, the third voltage V3(gk) is applied to the third sub-pixel in addition to the first voltage V1(gk) and the second voltage V2(gk) applied to the first sub-pixel and the second sub-pixel. When the grayscale gk is smaller than the predetermined grayscale gs, the relations ΔV13(gk)>0V, and ΔV12(gk)>ΔV13(gk) are satisfied. When the grayscale gk is equal to or greater than the predetermined grayscale gs, ΔV13(gk)<0V is set, and the relation ΔV13(gk)<ΔV13(gk+1) is satisfied.

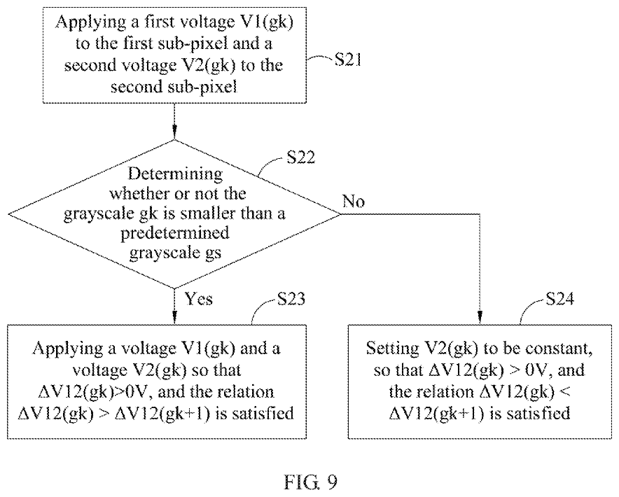

With reference to FIG. 9 for a flow chart of another liquid crystal display apparatus driving method in accordance with a preferred embodiment of the present invention, the method for driving the liquid crystal display apparatus is applicable for the liquid crystal display apparatus as shown in FIGS. 1 and 2, and the liquid crystal display apparatus includes a liquid crystal layer 11, and each pixel P includes a first sub-pixel P1 and a second sub-pixel P2, and a first source line SL1 and a second source line SL2 provide a voltage signal to the first sub-pixel P1 and the second sub-pixel P2 separately, and a same scan signal is provided to the first sub-pixel P1 and the second sub-pixel P2 through the gate line GL, and a voltage is applied to the first pixel P1 on the liquid crystal layer 11 through the first electrode 12a and a voltage is applied to the second pixel P2 on the liquid crystal layer 11 through the second electrode 12b. The method for driving the liquid crystal display apparatus includes the following steps (S21-S24):

Step S21: Applying a first voltage V1(gk) to the first sub-pixel and a second voltage V2(gk) to the second sub-pixel.

Step S22: Determining whether or not the grayscale gk is smaller than a predetermined grayscale gs. Like the previous preferred embodiment, Step S22 determines whether or not the grayscale is smaller than the predetermined grayscale gs or making the determination by comparing if the applied first voltage V1(gk) has reached a voltage value Vs(gs) of the predetermined grayscale gs.

If yes, go to Step S23: Applying a voltage V1(gk) and a voltage V2(gk) so that ΔV12(gk)>0V, and the relation ΔV12(gk)>ΔV12(gk+1) is satisfied.

If no, go to Step S24: Setting V2(gk) to be constant, so that ΔV12(gk)>0V, and the relation ΔV12(gk)<ΔV12(gk+1) is satisfied.

The aforementioned step may be executed according to the voltage control status as shown in FIG. 8A. If so, Step S23 satisfies the relation ΔV12(gk)=ΔV12(gk+1), and Step S24 also satisfies the relation ΔV12(gk)<ΔV12(gk+1). In addition, if the pixel is divided into three or more sub-pixels, the voltage control as described in Steps S23 and S24 has to add the voltage control of the third sub-pixel. When the grayscale gk is smaller than the predetermined grayscale gs, the voltage V1(gk) and voltage V3(gk) are applied, so that ΔV13(gk)>0V, and the relation ΔV12(gk)<ΔV13(gk) is satisfied. When the grayscale gk is equal to or greater than the predetermined grayscale gs, V3(gk) is set unchanged, such that ΔV13(gk)>0V, and the relation ΔV13(gk)<ΔV13(gk+1) is satisfied.

It is noteworthy that the description of a preferred embodiment may focus on a certain part while the other preferred embodiment has not given the details, and thus it is recommended to reference the relevant part from the related description of other preferred embodiments.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for driving a liquid crystal display apparatus, wherein the liquid crystal display apparatus comprises a liquid crystal layer; the liquid crystal layer is divided into a plurality of pixels; each pixel comprises a first sub-pixel and a second sub-pixel; and the pixels have a plurality of electrodes applying a voltage to the liquid crystal layer; and
the method for driving the liquid crystal display apparatus comprises the following steps:
when each of the pixels displays a grayscale gk, applying a voltage V1(gk) to the first sub-pixel, and applying a voltage V2(gk) to the second sub-pixel, and setting ΔV12(gk)=V1(gk)−V2(gk), wherein, 0≤gk≤n, and gk and n are integers greater than 0, and n stands for a highest-brightness grayscale;
when the grayscale gk is smaller than a predetermined grayscale gs, applying the voltage V1(gk) and the voltage V2(gk) such that ΔV12(gk)>0V, and the relation ΔV12(gk)>ΔV12(gk+1) is satisfied; and
when the grayscale gk is equal to or greater than the predetermined grayscale gs, setting V1(gk)=V2(gk) such that ΔV12(gk)=0V, and the relation ΔV12(gk)=ΔV12(gk+1) is satisfied.

2. The method for driving the liquid crystal display apparatus of claim 1, further comprises the following steps:
when a voltage V3(gk) is applied to a third sub-pixel which is different from the first sub-pixel and the second sub-pixel on the liquid crystal layer, setting ΔV13(gk)=V1(gk)−V3(gk);
when the grayscale gk is smaller than the predetermined grayscale gs, applying the voltage V1(gk) and the voltage V3(gk) such that ΔV13(gk)>0V, and the relation ΔV12(gk)<ΔV13(gk) is satisfied; and
when the grayscale gk is equal to or greater than the predetermined grayscale gs, setting V1(gk)=V3(gk) such that ΔV13(gk)=0V, and the relation ΔV12(gk)=ΔV13(gk) is satisfied.

3. The method for driving the liquid crystal display apparatus of claim 1, further comprising the following steps:
providing a voltage signal to the first sub-pixel and the second sub-pixel by a first source line and a second source line, respectively; and
providing a same scan signal to the first sub-pixel and the second sub-pixel by a gate line.

4. The method for driving the liquid crystal display apparatus of claim 1, wherein when the voltage V1(gk) is smaller than predetermined voltage Vs, applying the voltage V1(gk) and voltage V2(gk) such that ΔV12(gk)>0V, and the relation ΔV12(gk)>ΔV12(gk+1) is satisfied; and
when the voltage V1(gk) is equal to or greater than the predetermined voltage Vs, setting V1(gk)=V2(gk) such that ΔV12(gk)=0V, and the relation ΔV12(gk)=ΔV12(gk+1) is satisfied.

5. The method for driving the liquid crystal display apparatus of claim 1, wherein the highest-brightness grayscale n is 256.

6. The method for driving the liquid crystal display apparatus of claim 1, wherein the predetermined grayscale gs is 128.

7. The method for driving the liquid crystal display apparatus of claim 1, wherein the pixels are array pixels.

8. A method for driving a liquid crystal display apparatus, wherein the liquid crystal display apparatus comprises a liquid crystal layer; the liquid crystal layer is divided into a plurality of pixels; each pixel comprises a first sub-pixel and a second sub-pixel; and the pixels have a plurality of electrodes applying a voltage to the liquid crystal layer; and
the method for driving the liquid crystal display apparatus comprises the following steps:
when each of the pixels displays the grayscale gk, applying a voltage V1(gk) to the first sub-pixel and applying a voltage V2(gk) to the second sub-pixel, and setting ΔV12(gk)=V1(gk)−V2(gk), wherein, 0≤gk≤n, and gk and n are integers greater than 0, and n stands for a highest-brightness grayscale;
when the grayscale gk is smaller than a predetermined grayscale gs, applying the voltage V1(gk) and voltage V2(gk) such that ΔV12(gk)>0V, and the relation ΔV12(gk)=ΔV12(gk+1) is satisfied; and
when the grayscale gk is equal to or greater than the predetermined grayscale gs, setting V1(gk)=V2(gk) such that ΔV12(gk)=0V, and the relation ΔV12(gk)=ΔV12(gk+1) is satisfied.

9. The method for driving the liquid crystal display apparatus of claim 8, further comprising the following steps:
applying a voltage V3(gk) to a third sub-pixel which is different from the first sub-pixel and the second sub-pixel on the liquid crystal layer, and setting ΔV13(gk)=V1(gk)−V3(gk);
when the grayscale gk is smaller than the predetermined grayscale gs, applying the voltage V1(gk) and voltage V3(gk) such that ΔV13(gk)>0V, and the relation ΔV12(gk)>ΔV13(gk) is satisfied; and
when the grayscale gk is equal to or greater than the predetermined grayscale gs, setting V1(gk)=V3(gk) such that ΔV13(gk)=0V, and the relation ΔV12(gk)=ΔV13(gk) is satisfied.

10. The method for driving the liquid crystal display apparatus of claim 8, further comprising the following steps:
providing a voltage signal to the first sub-pixel and the second sub-pixel by a first source line and a second source line, respectively; and
providing the same scan signal to the first sub-pixel and the second sub-pixel by a gate line.

11. The method for driving the liquid crystal display apparatus of claim 8, wherein when the voltage V1(gk) is smaller than predetermined voltage Vs, applying the voltage V1(gk) and voltage V2(gk) such that ΔV12(gk)>0V, and the relation ΔV12(gk)=ΔV12(gk+1) is satisfied;
when the voltage V1(gk) is equal to or greater than the predetermined voltage Vs, setting V1(gk)=V2(gk) such that ΔV12(gk)=0V, and the relation ΔV12(gk)=ΔV12(gk+1) is satisfied.

12. The method for driving the liquid crystal display apparatus of claim 8, wherein the highest-brightness grayscale n is 256.

13. The method for driving the liquid crystal display apparatus of claim 8, wherein the predetermined grayscale gs is 128.

14. The method for driving the liquid crystal display apparatus of claim 8, wherein the pixels are array pixels.

15. A method for driving a liquid crystal display apparatus, wherein the liquid crystal display apparatus comprises a liquid crystal layer; the liquid crystal layer is divided into a plurality of pixels; each pixel comprises a first sub-pixel and a second sub-pixel; and the pixels have a plurality of electrodes applying a voltage to the liquid crystal layer; and
the method for driving the liquid crystal display apparatus comprises the following steps:
when each of the pixels displays the grayscale gk, applying a voltage V1(gk) to the first sub-pixel and applying a voltage V2(gk) to the second sub-pixel, and setting ΔV12(gk)=V1(gk)−V2(gk), wherein, 0≤gk≤n, and gk and n are integers greater than 0, and n stands for a highest-brightness grayscale;
when the grayscale gk is smaller than a predetermined grayscale gs, applying the voltage V1(gk) and voltage V2(gk) such that ΔV12(gk)>0V, and the relation ΔV12(gk)≥ΔV12(gk+1) is satisfied; and
when the grayscale gk is equal to or greater than the predetermined grayscale gs, setting V1(gk)=V2(gk) such that ΔV12(gk)=0V, and the relation ΔV12(gk)=ΔV12(gk+1) is satisfied.

16. The method for driving the liquid crystal display apparatus of claim 15, further comprising the following steps:
applying a voltage V3(gk) to a third sub-pixel which is different from the first sub-pixel and the second sub-pixel on the liquid crystal layer, and setting ΔV13(gk)=V1(gk)−V3(gk);
when the grayscale gk is smaller than the predetermined grayscale gs, applying the voltage V1(gk) and voltage V3(gk) such that ΔV13(gk)>0V, and the relation ΔV12(gk)>ΔV13(gk) is satisfied; and
when the grayscale gk is equal to or greater than the predetermined grayscale gs, setting V1(gk)=V3(gk) such that ΔV13(gk)=0V, and the relation ΔV12(gk)=ΔV13(gk) is satisfied.

17. The method for driving the liquid crystal display apparatus of claim 15, further comprising the following steps:
providing a voltage signal to the first sub-pixel and the second sub-pixel by a first source line and a second source line, respectively; and
providing a same scan signal to the first sub-pixel and the second sub-pixel by a gate line.

18. The method for driving the liquid crystal display apparatus of claim 15, wherein when the voltage V1(gk) is smaller than predetermined voltage Vs, applying the voltage V1(gk) and voltage V2(gk) such that ΔV12(gk)>0V, and the relation ΔV12(gk)≥ΔV12(gk+1) is satisfied;
when the voltage V1(gk) is equal to or greater than the predetermined voltage Vs, setting V1(gk)=V2(gk) such that ΔV12(gk)=0V, and the relation ΔV12(gk)=ΔV12(gk+1) is satisfied.

19. The method for driving the liquid crystal display apparatus of claim 15, wherein the highest-brightness grayscale n is 256.

20. The method for driving the liquid crystal display apparatus of claim 15, wherein the predetermined grayscale gs is 128.
